(19) United States
(12) Patent Application Publication
(10) Pub. No.: US 2025/0155568 A1
(43) Pub. Date: May 15, 2025

(54) MULTI-SPOT IMAGING USING SYNTHETIC APERTURE RADAR

(71) Applicant: ICEYE OY, Espoo (FI)

(72) Inventors: Alan Thompson, Espoo (FI); Pekka Laurila, Espoo (FI); Rafal Modrzweski, Espoo (FI)

(73) Assignee: ICEYE OY, Espoo (FI)

(21) Appl. No.: 18/722,328

(22) PCT Filed: Dec. 5, 2022
(86) PCT No.: PCT/EP2022/084407

§ 371 Date: Jun. 20, 2024

(30) Foreign Application Priority Data
Dec. 22, 2021 (GB) 2118747

(51) Int. Cl. G01S 13/90

(52) U.S. Cl. CPC G01S 13/9004; G01S 13/9041; G01S 13/9052; G01S 13/9056

(57) ABSTRACT

A method of operating a synthetic aperture radar “SAR” to acquire image data, comprises steering the SAR beam in azimuth with respect to the direction of travel during a first time period to acquire image data for a first area on Earth to be imaged; steering the SAR beam in azimuth during one or more additional time periods to acquire image data for one or more additional areas on Earth to be imaged; and steering the SAR beam in azimuth in a rearward direction with respect to the direction of travel, during a time period including the first and one or more additional time periods, to reduce the speed of travel of the beam with respect to Earth.

The invention is in the field of imaging using synthetic aperture radar.

### BACKGROUND

A Synthetic Aperture Radar (SAR) can be used to image an area on Earth may by sending out radar waves and recording the return echoes from those transmitted beams. SAR systems can be installed on airborne platforms such as aircraft, as well as in satellites operating from space. Various modes of operating the SAR can be used, such as such as stripmap, spotlight, and scanSAR.

In strip map mode, a satellite uses its SAR system to image data along a strip in the azimuth or along track direction of travel with respect to the surface of Earth. In scanSAR mode, multiple swaths are imaged along the strip by electronically steering the SAR beam in elevation (perpendicular to the satellite's direction of travel) to image different swaths as the satellite traverses the ground.

Classic spotlight mode imaging is a technique used to achieve high resolution imaging. In this mode, the satellite beam is steered in the azimuth direction in order to dwell on a spot on the ground for longer than it would typically spend on that area using the strip map or scanSAR modes. Spotlight mode can achieve high-resolution imaging by illuminating a ground site, or target area on the earth, over a longer period of time and over a wider range of angles than is possible without the beam steering. However, due to the need to steer the beam through significant angles between spotlight images, traditional SAR systems require significant gaps between spotlight images.

One problem that arises is how to image multiple closely-space spots. Operators of SAR systems are constantly aiming to improve the efficiency of image collection while maintaining the required resolution and accuracy, particularly in the field of satellite imagery but also in other implementations of SAR. Since classic spotlight mode typically allows for only imaging one contiguous spot on Earth at high resolution, imaging another close by spot would require completing another orbit (in the case of a satellite-mounted SAR) and coming back to the same area to image the second spot at high resolution. This is costly, inefficient, and results in delays to receiving the data in a timely manner.

Some embodiments of the invention described below solve some of these problems. However the invention is not limited to solutions to these problems and some embodiments of the invention solve other problems.

### SUMMARY

This summary is provided to introduce a selection of concepts in a simplified form that are further described below in the detailed description. This summary is not intended to identify key features or essential features of the claimed subject matter, nor is it intended to be used to determine the scope of the claimed subject matter.

Some embodiments of the invention provide a satellite, a ground station, a satellite system or a method of processing raw SAR data in which extended dwell times are used to obtain the raw data. In the case of the satellite, the extended dwell times may be achieved by mechanical steering of the satellite.

In one aspect there is provided in the following a method of operating a synthetic aperture radar “SAR” to acquire image data, wherein the SAR is carried on a platform travelling with respect to the surface of Earth and is directed toward the surface of Earth. The method comprises steering the SAR beam in azimuth with respect to the direction of travel during a first time period to acquire image data for a first area on Earth to be imaged; steering the SAR beam in azimuth during one or more additional time periods to acquire image data for one or more additional areas on Earth to be imaged; and steering the SAR beam in azimuth in a rearward direction with respect to the direction of travel, during a time period including the first and one or more additional time periods, to reduce the speed of travel of the beam with respect to Earth.

The steering during the first time period may be over a first range of angles and the steering during the one or more additional time periods may be over the same range of angles. The first and one or more additional time periods may overlap or they may be consecutive.

The steering of the beam in azimuth may be periodic during the time period including the first and one or more additional time periods.

The steering over the first range of angles may be in the forward direction. The SAR beam may be steered electronically over the first range of angles, for example using a phased array antenna.

The SAR beam may be steered in elevation between successive data acquisitions. This steering in elevation may also be electronic, for example using a phased array antenna.

The SAR beam may be steered mechanically in the rearward direction, for example by changing the orientation of the SAR with respect to the platform or by changing the orientation of the platform with respect to the surface of Earth.

There is also provided in the following a method of forming images of different areas on Earth comprising receiving requests for images of multiple areas on Earth, identifying a subset of the multiple areas that are sufficiently close for image data relating to those areas to be acquired during a prolonged dwell over a larger area including the identified areas, and determining a sequence of steering operations to be performed to enable image data relating to the subset of the multiple areas to be acquired during the prolonged dwell, and communicating the determined sequence of steering operations to SAR control equipment. The SAR may then be operated according to any of the methods described here.

There is also provided a computer readable medium comprising instructions which when implemented in a processor in a computing system cause the computing system to operate a SAR according to any of the methods described here.

There is also provided a satellite for operation in orbit around Earth according to any of the methods described here comprising a propulsion system, an attitude determination and control system “ADCS” configured for steering the SAR beam in a rearward direction, one or more radar antennas or antenna arrays configured for steering the SAR beam in azimuth over the first range of angles, synthetic aperture radar “SAR” image data acquisition apparatus, and a communication system configured to send and receive signals to and from one or more ground stations on Earth.

Embodiments of the invention also provide a computer readable medium comprising instructions, for example in the form of an algorithm, which, when implemented in a computing system forming part of a satellite operation system, cause the system to perform any of the methods described here.

Features of different aspects and embodiments of the invention may be combined as appropriate, as would be apparent to a skilled person, and may be combined with any of the aspects of the invention.

### BRIEF DESCRIPTION OF THE DRAWINGS

Embodiments of the invention will be described, by way of example only and with reference to the following drawings, in which:

FIG. 1 is a schematic perspective view of a satellite in orbit above Earth.

FIG. 2 is a schematic illustration of a satellite operating in SCANSAR mode.

FIG. 3 is a schematic illustration of a satellite operating to form images of multiple discrete areas on Earth.

FIG. 4 is a schematic diagram illustrating the effect of mechanically steering a satellite to slow down the effective ground speed.

FIG. 5 is a series of graphs illustrating superposition of mechanical steering in azimuth on electronic steering in azimuth and elevation.

FIG. 6 is a schematic diagram of components of a satellite.

FIG. 7 is a partial perspective view of a satellite.

FIG. 8 is a flow chart showing a method of forming images of different areas on Earth according to some embodiments of the invention.

Common reference numerals are used throughout the figures to indicate similar features.

### DETAILED DESCRIPTION

Embodiments of the present invention are described below by way of example only. These examples represent the best ways of putting the invention into practice that are currently known to the applicant although they are not the only ways in which this could be achieved.

Some embodiments of the invention provide systems and methods for operating SAR to obtain images of areas on Earth. For this purpose, a SAR may be carried on a platform travelling with respect to the surface of Earth. For example a SAR is commonly used onboard satellites. However, the methods and systems described here are not limited to space and may be performed using aircraft or any other suitable platform.

Some embodiments of the invention use a combination of mechanical and electronic steering of a radar beam to be described further here. The mechanical steering may be achieved by changing the orientation of a SAR antenna with respect to a platform, e.g. satellite or aircraft, on which it is carried. However, with a suitably agile satellite the mechanical steering may be achieved by changing the orientation of the whole platform with respect to a target, e.g. area on Earth. This is described in the following with reference to a satellite but it will be appreciated that the same principles may be applied to other kinds of platform.

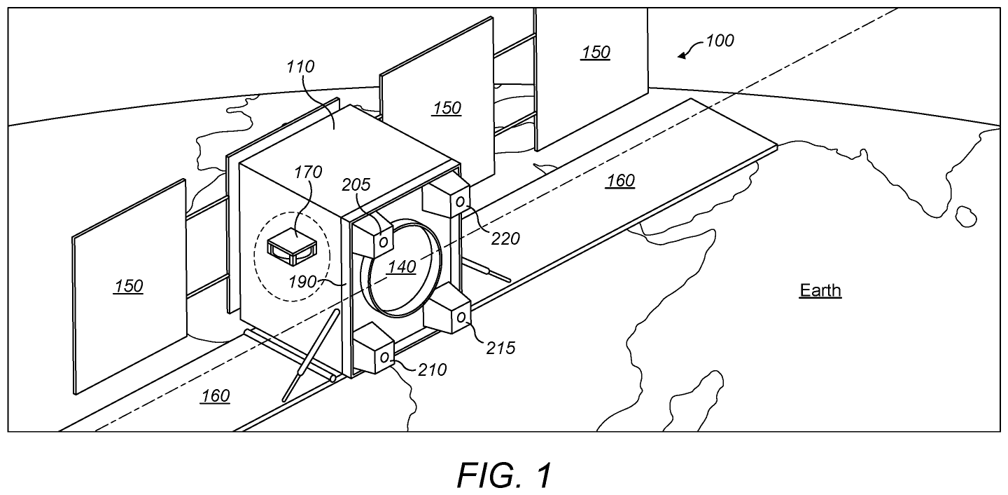

FIG. 1 is a perspective view of a satellite 100 in orbit over Earth as an example of a platform which may be used in the methods and systems described here. The satellite comprises a body 110 and “wings” 160. One or more antennas may be mounted on the satellite wings. Each antenna may comprise a phased array antenna, in other words each antenna may comprise multiple antenna components which may be controlled to steer the direction of the antenna beam, either to control the direction and shape of a transmitted pulse or to control the direction and area from which radiation may be received. This is electronic beam steering and is well known in the art. References here to beam steering or electronic steering are intended to refer to steering of a radar beam using a phased array antenna for transmission or reception.

Electronic beam steering has a high accuracy and takes place rapidly. Accordingly, small angles can be steered quickly. This is also referred to as rapid small angle electronic steering. Electronic beam steering can be performed in two dimensions (azimuth and elevation).

The satellite 100 may be configured for mechanically steering the antenna, and hence the SAR beam, in addition to the electronic steering. In this example this is achieved by steering the whole satellite 100. This may be achieved using the satellite attitude determination and control system ADCS, which may be provided with one or more reaction wheels, one of which is indicated at 170. Mechanical beam steering allows wider steering angles than electronic steering does, and thus can provide for a wide ground coverage, particularly for small and agile satellites with the ability to slew at sufficiently fast speeds with lower power consumption. Using this technique, larger angles can be steered. This is also referred to as large angle mechanical steering. In some of the methods described here, the mechanical steering may be sufficiently fast to reduce the effective ground speed of the radar beam or even reduce it to near zero. However, the mechanical steering is still relatively slow compared to electronic steering.

As is known in the art, a SAR is operated to alternate periodically between transmission mode in which a pulse of radiation is directed towards the surface of Earth and reception mode in which radiation reflected from the surface is received.

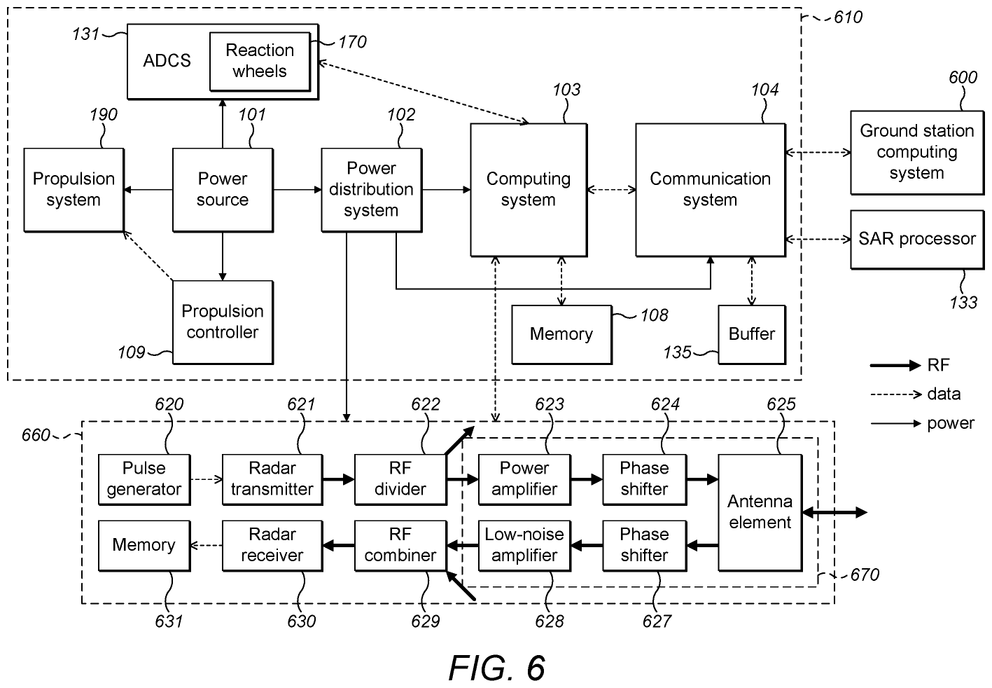

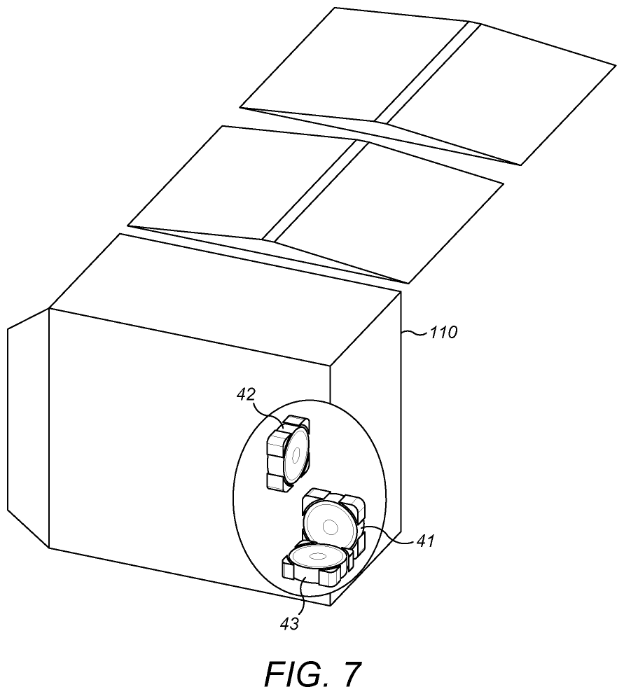

Further details of the satellite of FIG. 1 are described with reference to FIGS. 6 and 7.

As is known in the art, to create a SAR image, successive pulses of radio waves are transmitted to “illuminate” a target scene, and the echo of each pulse is received and recorded. The pulses can be transmitted and the echoes can be received using a single beam-forming antenna. As the SAR is carried on board a moving platform, such as a satellite, and therefore moves with respect to the target, the antenna location relative to the target changes with time and the frequency of received signals changes due to the Doppler effect. Signal processing of the successive recorded radar echoes allows the combination of recordings from multiple antenna positions thereby forming the synthetic antenna aperture to allow creation of higher resolution images.

An area currently captured by the SAR is a footprint. A direction along the flight direction of the SAR is usually referred to as azimuth or along track. A direction transverse to the flight direction is usually referred to as range, elevation or cross-track. A direction opposite to the flight direction corresponds to the backward azimuth direction.

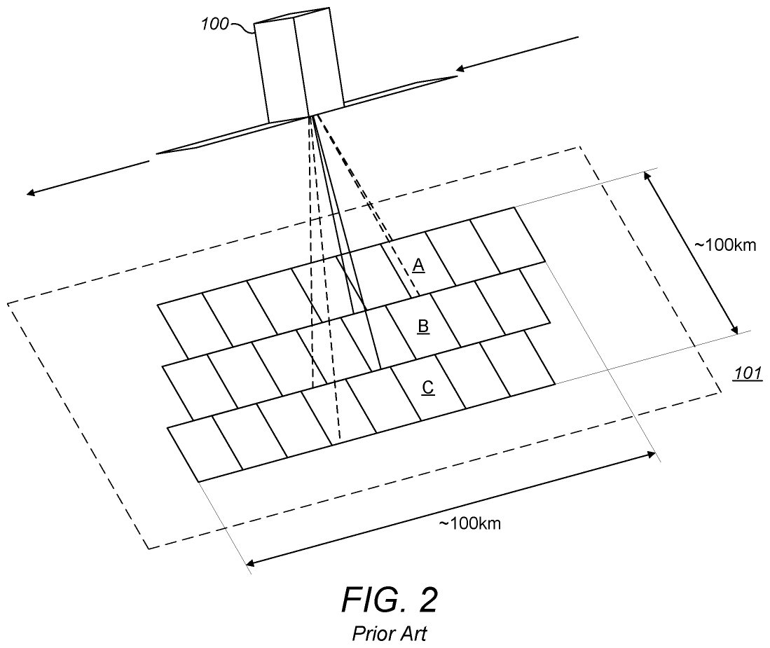

FIG. 2 is a schematic illustration of a satellite 100 operating in ScanSAR mode. The satellite 100 is in a well-known side-looking configuration in which it sends and receives signals from an area to the side of the satellite rather than directly below it. This area has a width, also known in the art as the swath. For each radar pulse transmitted from the satellite, signal data in the form of echoes may be received from different points across the swath, at different frequencies due to the Doppler effect which is central to SAR.

The satellite 100 is shown to be travelling from right to left as indicated by the arrow with respect to Earth in its orbit. In ScanSAR mode, an area from which data is to be collected, for example the 100 km×100 km area indicated in FIG. 2, is divided into sub-swaths, and each sub-swath is divided in the direction of travel into what are referred to here as “blocks”, forming an offset chequerboard pattern in the example of FIG. 2. The SAR beam may be steered in elevation to collect data from different sub-swaths. During this steering, echoes are received from different positions across a sub-swath to provide a set of data for each square (or other shape), e.g. block A, on the ground.

Electronic steering can be achieved very quickly. In a development of ScanSar known generally as Terrain Observation with Progressive Scans, or TOPS, after the SAR beam has been steered to the edge of block A, it is steered rapidly in elevation electronically to the adjacent sub-swath, and back in azimuth to its starting azimuth angle, to repeat the steering in azimuth to collect data from a second block B, and so on.

Each traverse of the beam in azimuth may correspond to a few hundred pulses, referred to here as a “burst”. Thus a burst corresponds to a block on the ground, and data over the length of a swath is collected in a burst-by-burst approach.

The resolution of an image depends on a number of factors including the amount of data that was acquired to generate the image. A technique used to achieve high resolution imaging is the known spotlight mode, in which the SAR beam is steered to dwell on a particular area. However, this technique is typically used to image only one spot or area. Further, this dwelling leads to a need to “recover” the satellite by steering it back to its original orientation before it can take another image, during which time the satellite will have travelled in its orbit and therefore it is not possible to form such high-resolution images of closely spaced “spots”. In other words, significant spatial gaps are often required between spotlight images. To image another spot or area that is close to the first spot, the satellite may need to complete at least one full orbit to return to the original point, which is very costly in terms of time and efficiency.

In some of the methods and systems to be described in more detail in the following, mechanical steering of the SAR beam in the rearward direction is superimposed on electronic steering of the beam in the forward direction. The effect of the mechanical steering is to reduce the speed of travel of the beam with respect to the earth as the satellite travels in its orbit. This may allow higher burst durations and therefore higher resolution images. In some implementations the mechanical steering may be used to bring the beam to a standstill, or near standstill, with respect to the ground. This rearward steering combined with electronic steering in one or both of azimuth and elevation can permit higher resolution images to be acquired from multiple closely spaced spots, something that was not previously possible.

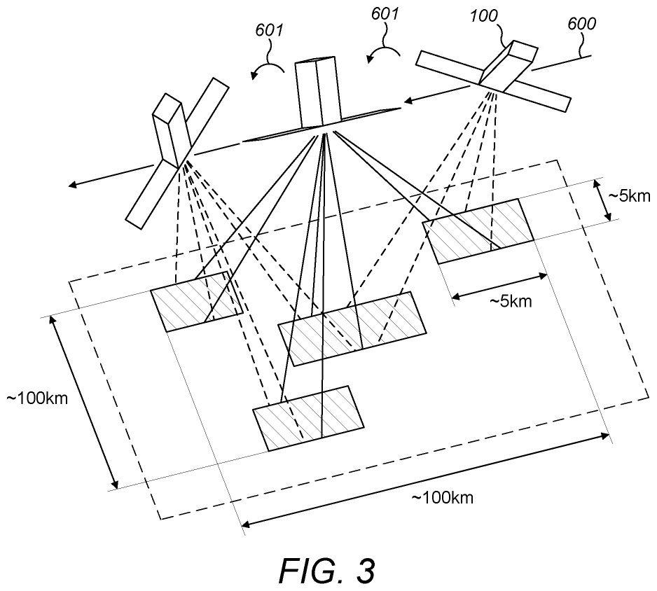

This mechanical steering is illustrated in exaggerated form in FIG. 3, where the satellite 100 is shown to have a different orientation at each of three positions along its path 600. Between each position the satellite has rotated in azimuth as indicated by the arrows 601.

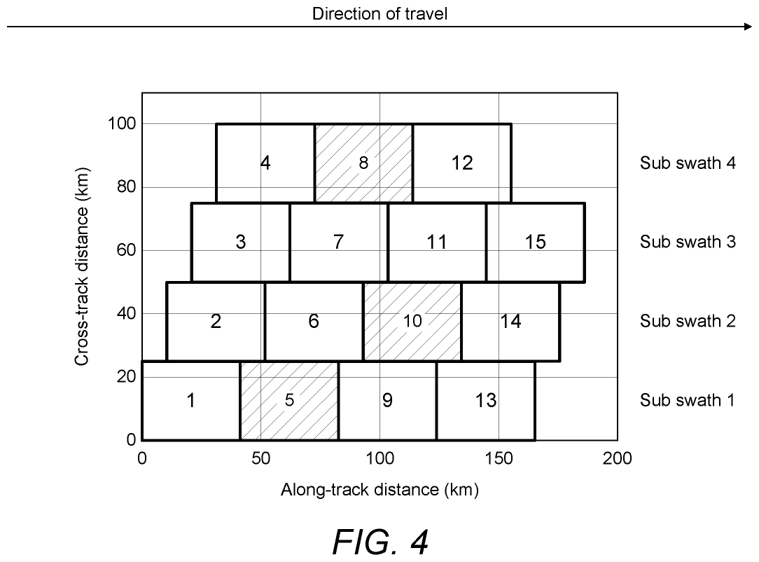

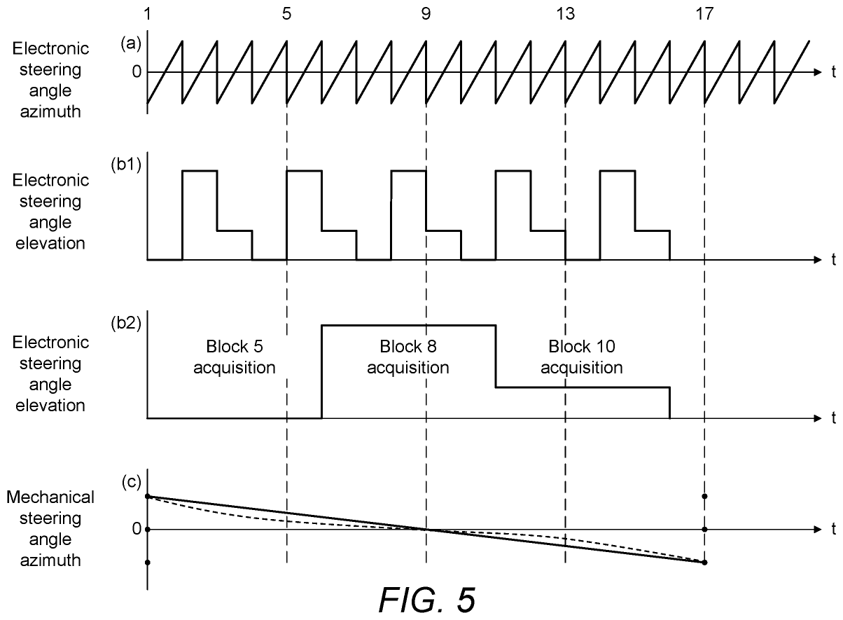

Some examples of superimposing electronic and mechanical steering will now be described with reference to FIGS. 4 and 5. FIG. 4 depicts an area on the ground divided into smaller areas, or blocks, as it might be for operation of SAR in ScanSAR mode or TOPS mode. Thus as previously described, the SAR beam may be steered electronically to collect data from blocks 1-15 in turn in numerical order.

To do this, the beam may be steered forward in the azimuth (along-track) direction periodically, as shown in FIG. 5(a), where the beam angle is steered from a negative angle through zero to an equal positive angle over a burst period, and this is repeated for successive bursts over the same range of angles. Superimposed on this periodic electronic forward steering in azimuth is mechanical rearward steering in azimuth over a larger range of angles and for a longer period. FIG. 5(c) shows a simplified example for the purpose of illustration with 16 forward electronic scans over the course of one relatively slow backwards mechanical scan. In a practical implementation the ratio of the mechanical azimuth steering period to the electronic steering period would be at least 2:1 in order to allow at least two spots for every mechanical scan. In some implementations of methods described here, the electronic steering in azimuth is repeated periodically as the beam is mechanically steered in azimuth, whereas the mechanical steering is not repeated periodically. It should be noted that although the graphs shown the electronic and mechanical steering being linear this need not necessarily be the case, particularly for the backward mechanical azimuth steering.

The electronic steering in azimuth shown in FIG. 5(a) is similar to the steering carried out in TOPS, where the beam is rapidly returned to the starting angle between each “sweep” across the range of azimuth angles. This rapid return is not essential to the methods described here and in some implementations the beam may be steered slowly in the opposite direction while pulses continue to be transmitted, for example at the same rate as the forward steering. Further, it is not essential for the electronic azimuth steering to be in the forward direction. The improvement in resolution and/or spacing between spots is principally derived from the electronic azimuth steering combined with the mechanical steering rearward with respect to the direction of travel of the satellite in the orbit. The electronic steering in azimuth may be periodic within the duration of the mechanical steering but this is not essential as explained further below.

Some implementations of imaging methods described here may be used to form images of different “spots”, i.e. areas or blocks, in the same sub-swath. In that case, no steering in elevation is required. The spots may be consecutive, overlapping, or non-contiguous. In the case of overlapping spots, some data from a first spot may be used in the formation of an image of an overlapping spot, and no additional steering is required.

Other implementations may be used to form images of spots, or blocks, in different sub-swaths. Consider for example the satellite receiving a request to form images of, or transmit image data for, areas/blocks 5 (in sub-swath 1), 8 (in sub-swath 4) and 10 (in sub-swath 2) as shown in FIG. 4. The graphs of FIG. 5 show two ways in which this could be achieved. There are two graphs (b1) and (b2) for two different possible implementations where the elevation steering is periodic sub-swath to sub-swath (b1) or one spot at a time (b2), each directed to a block in the first, fourth and then second sub-swath (e.g. blocks 5, 8, 10 in FIG. 4). These are two examples of a range of possibilities for how each separate block is imaged, which may be determined according to what “spots” (e.g. their location and desired resolution) are required to be imaged.

In the example of FIG. 5 (b1), the beam is steered in the elevation (cross-track) direction between each burst, or complete sweep in azimuth, from one sub-swath to another (in the order 1, 4, 2, 1, and so on), so that data is collected periodically during the duration of the mechanical steering (FIG. 5 (c)). The ratio of bursts to mechanical steering duration is exaggerated in this figure and in practice would be much larger. Therefore an alternative option would be for the electronic steering to take place every n bursts, where n is an integer, whilst still achieving periodic collection of data from different blocks during the mechanical steering duration.

In the example of FIG. 5 (b2) the beam is steered in the elevation (cross-track) direction such that data from each of blocks 5, 8 and 10 (FIG. 4) is collected during a continuous period within the mechanical steering duration. Thus the beam is steered from sub-swath 1 (to image block 5) to sub-swath 4 (to image block 8) after 5 bursts or electronic sweeps in azimuth, and from sub-swath 4 to sub-swath 2 (to image block 10) after a further 5 sweeps in azimuth.

It is not essential for data corresponding to different areas to be collected continuously as shown in FIG. 5 and there may be gaps between bursts, for example between acquisitions of data for different areas or “spots”. Also, the range of angles swept during each burst need not be the same. Indeed they may be different due to the travel of the satellite and/or the mechanical steering during each burst. For example the range of angles during the azimuth scans of burst 1 and burst 5 might be slightly different for each burst.

In these examples, data is collected from the respective blocks in their order along the direction of travel of the satellite, but since the effective ground speed of the SAR beam may be near stationary due to the mechanical steering this is not essential and signals from the different blocks may be collected in any order. Also in these examples, the time period during which data is collected from different blocks is equal, but this is not essential and the time period may vary for example due to different requirements for different blocks.

In the examples of FIG. 5 (b1) and (b2) there are multiple electronic sweeps in azimuth corresponding to each block, five sweeps as illustrated. Imaging the blocks multiple times does not provide increased resolution but provides for a higher diversity of viewing angles. When combined, pixels can be averaged in order to reduce “speckle” resulting from bright returns in particular pixels. This is known as “multi-looking”. In general, the electronic steering in azimuth can be varied and can be controlled to be fast or slow whilst still being faster than the mechanical steering so as to scan a block during the duration of the mechanical steering. For example the electronic steering in azimuth can be slowed to the extent that data for each block is collected in a single electronic azimuth sweep. Slowing down the electronic azimuth sweep and scanning each spot in one long burst allows for higher resolutions to be achieved. In other words, the mechanical steering in azimuth allows longer burst durations (where a burst corresponds to an electronic azimuth sweep) or the collection of data relating to the same block over multiple bursts.

In all of the examples described above, the SAR beam is steered in azimuth with respect to the direction of travel over a first range of angles during a first time period to acquire image data for a first area, or block, to be imaged, for example as shown by a sweep in azimuth shown in FIG. 5(a). This steering is repeated during one or more additional time periods to acquire image date for one or more additional blocks to be imaged, over the same or a different range of azimuth angles. At the same time, the SAR beam is steered in a rearward direction with respect to the direction of travel, for example over a second, different, range of angles, during a time period including the first and additional time periods, to reduce the speed of travel of the beam with respect to Earth, as shown for example in FIG. 5(c). Thus due to the rearward steering of the SAR beam, multiple high resolution “spots” may be acquired more closely spaced than has been possible to date. The solid line in FIG. 5(c) shows the azimuth angle being varied linearly with time as a result of the mechanical steering. The dotted line shows an alternative implementation in which the angle changes faster at the start of a steering period, slowest when crossing zero azimuth angle and faster towards the end, in order to keep the beam speed constant with respect to the ground. The rate of change of azimuth angle may be varied in any way including a combination of linear and non-linear progress according to the specific implementation.

As shown in FIG. 5, the time periods during which data is collected for different blocks may be interleaved as shown in FIG. 5 (b1) where data for one block is collected in successive bursts interleaved between other bursts during which data is collected for one or more other blocks. Alternatively the time periods may be consecutive as shown in FIG. 5 (b2) where during the time period corresponding to each block there may be one slow sweep, or several consecutive sweeps in azimuth as shown in FIG. 5(a).

The steering of the beam in azimuth may be periodic during the rearward steering period which includes the first and one or more additional time periods, during which data is collected corresponding to different areas, or blocks, as shown in FIG. 5(a).

The SAR beam may be steered in elevation between successive data acquisitions, for example where the different areas or blocks from which data is to be collected are in different sub-swaths. Notably image data for different areas visible as the SAR beam is mechanically steered may be acquired in any order and not necessarily in the direction of travel or sequentially across the swath, although both are possible.

As noted elsewhere, the methods described here are particularly but not exclusively suited to implementation in connection with a SAR carried on a satellite. A satellite suitable for use in implementing the invention will now be described with reference to FIGS. 1, 6 and 7. It will be appreciated that the longer the beam dwells at a particular location, the larger is the range of angles required of the satellite mechanical steering and the longer it will take to make up the “gap” in the path of travel along the orbit caused by this dwelling. Therefore there will be a gap between successive areas that can be imaged while the satellite rotates back to its original position, similar to classic spotlight mode. However, if all of the spots are closely spaced (e.g., within a 100 km by 100 km area), then they can all be imaged in one pass and the impact of the gap is minimized.

FIG. 6 is a schematic diagram representation of the components of a satellite, for example a micro satellite, according to some embodiments of the invention. Solid arrows between components are used to indicate power connections, heavier solid arrows are used to indicate RF signal connections, and dashed lines are used to indicate data connections.

Some components are part of the satellite “bus” 610, indicated by a rectangle in FIG. 6, and some may be part of the “payload” 660, indicated by a rectangle in FIG. 6. Other components are part of an antenna module 670, also indicated by a rectangle in FIG. 6. The satellite components shown in FIG. 6 comprise a power source 101 and a power distribution system 102. The power source 101 and power distribution system 102 supply power to a propulsion system 190, propulsion controller 109, attitude determination and control system “ADCS” 131, computing system 103, buffer 135, and a communication system 104. The power source 101 and the power distribution system 102 also supplies power to components within the payload 660, such as the pulse generator 620 and the power amplifier 623. The buffer 135, although shown as a separate item, may be comprised in the computing system 103. The propulsion controller 109 is shown here as a separate item but in practice it may form part of the computing system 103. The propulsion controller may be controlled either through the use of control software implemented in one or more processors comprised in the propulsion controller 109 or in response to received instructions, for example from the computing system 103. Where the instructions are transmitted from the computing system 103, the computing system may be considered to comprise a propulsion controller. One of the functions of the propulsion controller 109 may be to output control signals to ion sources and electron sources of thrusters in the propulsion system 190.

The satellite bus 610 may generally be located in the body 110 of the satellite 100 as shown in FIG. 1. Power distribution system 102 may comprise control logic as is known in the art. The communication system 104 may include one or more communication antennas, for example located on the satellite body 110. Alternatively, the communication system 104 may send and receive signals via one or more communication antennas located on a wing 160 of the satellite.

In the case of an earth observation satellite, the satellite payload 660 may include one or more radar antenna arrays, which may be located at one or more wings 160 of the satellite. FIG. 6 shows a single antenna element 625 which may be part of a phased array antenna used for SAR imaging. Antenna element 625 transmits and receives signals 626. Antenna element 625 is shown to have an associated power amplifier 623 and phase shifter 624 for transmitting the radar signal, and an associated low-noise amplifier 628 and phase shifter 627 for receiving the return signal. Together these form an antenna module 670. The phased array antenna can comprise multiple antenna modules 670. In an example, a satellite mounted phased array antenna comprises 320 antenna elements and associated amplifiers and phase shifters. Different phased array antennas will have different numbers of antenna elements depending on their design and intended purpose. The electronic steering of the antenna is achieved by phase shifting individual antenna components via phase shifters 624 and 627 as is known in the art.

A pulse generator 620 generates a RF signal that is sent to the radar transmitter 621. The radar signal is sent to the RF divider 622 and that divides the RF signal and sends it to multiple antenna modules 670. One antenna module 670 is shown in FIG. 6, but there can be multiple antenna modules. A RF combiner 629 receives the combined signals from the multiple antenna modules 670 and sends the received RF signal to the radar receiver 630. The data is stored in memory 631. Memory 631 may be the same or separate from memory 108. The pulse generator 620, radar transmitter 621, radar receiver 630, RF divider 622, and RF combiner 629 can be located in either the satellite body 110 or on the satellite wing 160. The additional arrow extending from the RF divider 622 in FIG. 6 indicates one or more additional RF outputs from the RF divider 622 to one or more additional antenna modules, and the additional arrow pointing to RF combiner 629 indicates one or more additional RF inputs going into RF combiner 629 from one or more additional antenna modules.

The methods and systems described here refer to the steering of a single antenna or a single aperture. However, they may be readily extended to systems comprising multiple antennas or multiple apertures.

The antenna modules 670, multiplied for the number of antenna modules, collectively form the image acquisition apparatus of the satellite, as is known to those skilled in the art. They may perform functions other than the acquisition of image data.

In a typical satellite an antenna may comprise a phased array antenna as noted above. A phased array antenna, with antenna elements spatially distributed over two dimensions perpendicular to the radar-range dimension, may allow two-dimensional beam steering in azimuth and elevation.

The available electronic steering of a phased array antenna may be limited by the physical antenna in range and spacing of phase centres in azimuth resulting in reduced gain/grating lobes if too much steering is attempted. The limits on available angle ranges will vary from one physical apparatus to another but limits for a typical satellite designed for low earth orbit might be set at ±25° in elevation and ±2° in azimuth.

The payload 660 receives power from the power distribution system 102 and instructions from computing system 103. Data from the payload 660 such as received radar signals also flows back to the computing system 103 and can be stored in memory 108. The data may be processed by the computing system 103, for example to generate images as described elsewhere here, which may then be output to the communication system 104 for onward transmission. In the system illustrated in FIG. 6, raw data can also be output by the computing system 103 to the communication system 104 which further transmits it for processing by a remote computing system. In FIG. 6, a SAR processor 133 may be located at a ground station 600, for example, or in another processing location. The computing system 103 may send operating instructions to other components located in the payload 660, such as the radar transmitter 621, the radar receiver 630 and/or the phase shifters 624 and 627, as will be familiar to those skilled in the art. Raw SAR data can be stored in the satellite in memory 108 or 631. Memory 108 and 631 could be the same or different memort modules or could also be part of computing system 103.

Raw SAR data stored in buffer 135 may be communicated to a ground station 600 or a remote SAR processor 133. In an example, 30 seconds of image data can be stored at full resolution (bandwidth) in the buffer 135. More can be stored at lower resolution (e.g., 60 seconds at half resolution). In an example, a micro satellite has a 150 MBs download link. At this data rate it takes about 3 minutes to download the 30 seconds of full resolution imagery data.

The communication system 104 may communicate with earth stations or other satellites using radio frequency communication, light, e.g. laser communication, or any other form of communication as is known in the art.

A satellite, for example satellite 100 of FIG. 1, is generally provided with a propulsion system 190 for maneuvering the satellite with a generated thrust. The propulsion system 190 is shown in FIG. 1 to be mounted on the body 110 on the surface opposite the solar panels 150.

As shown in FIG. 1, the propulsion system 190 comprises a plurality of thrusters 105 that produce thrust for maneuvering the satellite 100 when required.

The thrusters 105 are generally operated to maintain the satellite in a particular orbit. For example the thrusters may be used to propel the satellite in a particular direction with respect to the surface of the earth.

Referring back to FIG. 6, the ADCS 131 is usually located in the satellite body 110 and is used to control the orientation of the satellite. ADCS may be implemented in a number of ways. The ADCS 131 is shown in the figures to comprise a set of reaction wheels, one of which is indicated schematically in FIG. 1. The reaction wheels are usually, but not necessarily, located in the satellite body 110. FIG. 7 is a partial perspective view of a satellite and shows a set of three reaction wheels 41, 42, 43 located in the satellite body 110. Reaction wheels are sometimes also known as momentum wheels.

In the satellite described here, the ADCS may be used to mechanically steer the satellite to maintain a target area on Earth within the radar aperture, in other words in sight of the satellite, for a longer period than the target would be visible without mechanical steering as the satellite travels in its orbit. In principle the range of angles for mechanical steering is limited only by the horizons in each direction, but the greater the angle, the larger is the distance to the target area and hence the weaker is the returned signal. In the methods described here, a suitable range of mechanical steering angles is −45° to +45°, but higher ranges for example −60° to +60° could also be possible.

Reaction wheels 41, 42, 43 function by using an electric motor to spin a wheel inside the spacecraft body 120. By conservation of angular moment, since there are no external forces in space, spinning the wheel in one direction causes the spacecraft to rotate in the opposite direction. Using reaction wheels is a well-known way of orienting spacecraft such as satellites.

In an example, three reaction wheels are positioned inside a spacecraft body, one for orienting the satellite in each axis. Thus reaction wheels 41, 42, 43 are shown to have orthogonal axes.

In another example, four or more reaction wheels may be used in order to have better control over various aspects of the satellites dynamics, such as slew rate (how fast the satellite can turn) and fine positioning control, particular for satellites with higher moments of inertia. This technique may contribute to the ability to dwell on a certain point on the earth's surface, discussed further elsewhere here, but is not essential.

Various classes of satellites are currently in orbit around the earth, generally defined by ranges of weights, although the boundaries between the classes are somewhat fluid and arbitrary:

Cube satellites: 1 kg-10 kg

Micro satellites: 50 kg-to 250 kg

Small satellites: 500 kg-800 kg

Regular satellites: 800-1200 kg.

Large satellites: >1200 kg.

Reaction wheels are rated in terms of their “momentum capacity”, which has units of nms (newton-metre-seconds). The slew rate is related to the speed of the wheel and the inertia of the satellite system. A satellite having a particularly low mass has a much lower moment of inertia than traditional larger SAR satellites. A suitably low mass may be under 1000 Kg, for example under 500 Kg, under 250 Kg, between 50 Kg and 250 Kg, or under 100 kg.

Very small cube satellites do not at present have the capability to carry a current SAR payload. Heavier satellites are generally less agile due to their higher inertia. Embodiments of the satellite and operating methods described here have been successfully implemented in a micro satellite.

Embodiments of the invention are particularly applicable to the class of satellites known as micro satellites.

Some of the methods to be described further here benefit from reaction wheels within a particular rating range. A suitable range for example for micro satellites can be 0.5 to 2.5 nms. Reaction wheels with a rating of 1 nms have been successfully trialed. This has enabled slew in the range of 1°/second, which is sufficient to track a spot on the ground and to implement any of the methods described here without consuming too much power. Thus in any of the satellites described here, the ADCS may be configured to slew the satellite in the azimuth direction at up to 1 degree/second using mechanical steering. Additionally or alternatively the ADCS may be configured for a dwell time of up to 60 seconds.

Larger satellites are known to use reaction wheels of the order of 10 nms, but they are not currently able to achieve slew rates sufficient for the dwell times discussed further here due to the large mass of the satellites and the resulting high rotational inertia, and they also consume much more power than the smaller reaction wheels.

In an example, the satellite is orbiting Earth in a low-earth orbit. A low-earth orbit can be from 160 km to 1000 km above the surface of the Earth. Examples of Earth-observation satellites based on SAR according can have orbits of between 450 km and 650 km above the Earth. In an example according to the current invention, a satellite has an orbit that is 550 km above the Earth's surface. At an orbit of 550 km above the Earth, for example, the satellite is effectively traversing the ground at about 7.5 km/s, or 27,000 km/h. Most satellites in this this orbit will traverse the Earth at a speed that is in the range of 7-8 km/s.

In some embodiments, in order to dwell on and keep the SAR antenna pointed to a point on the earth, the micro satellite may be designed to be able to rotate with a slew rate ability of the order of 1°/sec. This has not been achievable mechanically with traditional satellites. However, according to some embodiments of the invention, a satellite such as a micro satellite can slew at a speed necessary to maintain pointing at a spot on Earth for about 10 minutes from horizon to horizon. However, at the extremes of this range the distance to the spot or target being imaged is too far to get a good SAR image, so there is a smaller practical dwell time.

As noted elsewhere here, embodiments of the invention are not limited to changing the orientation of the whole satellite, which is convenient in the case of the small, lightweight, agile satellites described above. For example, in some embodiments, the mechanical steering may be achieved by changing the orientation of an antenna with respect to a satellite on which it is carried.

In the foregoing only one SAR beam has been considered. However it will be appreciated that the methods and systems described here may be extended to the use of multiple SAR beams. For example a platform might carry apparatus for multiple SARs, each of which may be operated according to any of the methods described here.

To give a specific example for the purpose of illustration only, for a satellite travelling 7.5 km/s at 550 km above the Earth, ignoring the curvature of the Earth, this means in 30 seconds the satellite will travel 225 km away from directly over the target. To still be pointing directly at the same point on Earth for the whole 30 second period an angle range of about 23 degrees is required. Different implementations may use different ranges of angles. This may depend on factors such as but not limited to the ability of the mechanical steering and the capacity of the satellite on board memory, since data is usually downloaded in batches when passing over a ground station.

It will be appreciated from the foregoing that all of the methods described here benefit from the use of an agile micro satellite. A suitably sized micro satellite can rotate to observe a target for an extended period of time (up to 60 seconds). This provides them the unprecedented capability of achieving many frames of imagery at the same resolution as the range resolution over a period of time.

There is described in the foregoing a satellite suitable for implementing any of the methods of operation described here. For a satellite or other platform already in orbit, the methods described here may be implemented by suitably controlling the satellite, for example from the ground using a suitable computing system, for example ground station computing system 600. In other words a SAR may be operated from the ground and some of the methods described here may be implemented in software. Therefore in an aspect the invention may provide a computer readable medium comprising instructions which, when implemented by a processor in a computing system, cause the computing system to operate a SAR according to any of the methods described here.

The acquisition of SAR image data as described here may have many different practical applications. An end-to-end process may begin with a request to image particular spots in an area, for example they may be requested by a customer or identified as interesting by an algorithm. A sequence of moves in azimuth and optionally elevation may then be devised to best acquire the image data, for example using any combination of FIG. 5 (a), (b1) and (b2). Then when the satellite is next over the general area it will “stop”, the steering will be performed, and the image data collected.

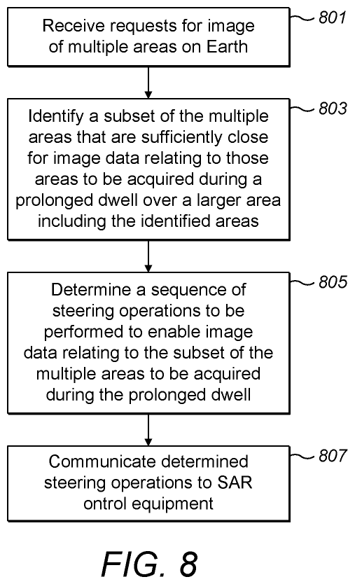

A method as shown for example in FIG. 8 may comprise 801 receiving requests for images of multiple areas on Earth, 803 identifying a subset of the multiple areas that are sufficiently close for image data relating to those areas to be acquired during a prolonged dwell over a larger area including the identified areas, and 805 determining a sequence of steering operations as described here to be performed to enable image data relating to the subset of the multiple areas to be acquired during the prolonged dwell. Thus the steering operations may include steering the SAR beam in azimuth with respect to the direction of travel during a first time period to acquire image data for a first area on Earth to be imaged; steering the SAR beam in azimuth during one or more additional time periods to acquire image data for one or more additional areas on Earth to be imaged; and steering the SAR beam in azimuth in a rearward direction with respect to the direction of travel, during a time period including the first and one or more additional time periods, corresponding to the prolonged dwell, to reduce the speed of travel of the beam with respect to Earth.

Operations 801-805 may take place at a ground computing system 600. Alternatively one or more of operations 801-805 may take place at the on-board computing system 103. Either way the sequence of steering operations may be communicated 807 to the SAR control equipment, such as phase shifters 111 and ADCS 131. A SAR may then be operated according to any of the methods described here to obtain the image data.

Some embodiments of the invention described here provide the following:

A ground station computing system configured to operate a SAR according to any of the methods described here.

A satellite with an antenna that can point to an observation area and maintain its pointing to the same location for an extended period of time (60 seconds). This is usually far longer than a larger satellite is able to achieve (nominally 2 seconds) due to low mass and low moment of inertia thereby permitting antenna and beam pointing to be achieved without expenditure of fuel and using only internal momentum wheels.

A mode of imaging that can maintain a target scene within an antenna receive window even though the range to the target scene has a range that varies considerably.

In any of the embodiments of the invention, the satellite may be travelling in, or configured to travel in a low earth orbit.

A satellite according to any of the embodiments of the invention may be configured for side-looking, as is known in the art. It may have both left-looing and right-looking capability.

A satellite according to any of the embodiments of the invention may use x-band radar.

Any of the computing systems described here may be combined in a single computing system with multiple functions. Similarly the functions of any of the computing systems described herein may be distributed across multiple computing systems.

Some operations of the methods described herein may be performed by software in machine readable form e.g. in the form of a computer program comprising computer program code. Thus some aspects of the invention provide a computer readable medium which when implemented in a computing system cause the system to perform some or all of the operations of any of the methods described herein. The computer readable medium may be in transitory or tangible (or non-transitory) form such as storage media include disks, thumb drives, memory cards etc. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The embodiments described above are largely automated. In some examples a user or operator of the system may manually instruct some steps of the method to be carried out.

In the described embodiments of the invention the system may be implemented as any form of a computing and/or electronic system as noted elsewhere herein. For example the ground station may comprise such a computing and/or electronic system. Such a system may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The term “computing system” is used herein to refer to any device with processing capability such that it can execute instructions. Those skilled in the art will realise that such processing capabilities may be incorporated into many different devices and therefore the term “computing system” includes PCs, servers, smart mobile telephones, personal digital assistants and many other devices.

It will be understood that the benefits and advantages described above may relate to one embodiment or may relate to several embodiments. The embodiments are not limited to those that solve any or all of the stated problems or those that have any or all of the stated benefits and advantages.

Any reference to “an” item or “piece” refers to one or more of those items unless otherwise stated. The term “comprising” is used herein to mean including the method steps or elements identified, but that such steps or elements do not comprise an exclusive list and a method or apparatus may contain additional steps or elements.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A method of operating a synthetic aperture radar (SAR) to acquire image data, wherein the SAR is carried on a platform travelling with respect to the surface of Earth and is directed toward the surface of Earth, the method comprising:
steering the SAR beam in azimuth with respect to the direction of travel during a first time period to acquire image data for a first area on Earth to be imaged;
steering the SAR beam in azimuth during one or more additional time periods to acquire image data for one or more additional areas on Earth to be imaged; and
steering the SAR beam in an azimuth in a rearward direction with respect to the direction of travel, during a time period including the first and the one or more additional time periods, to reduce the speed of travel of the beam with respect to Earth.

2. The method of claim 1, wherein the steering during the first time period is over a first range of angles and the steering during the one or more additional time periods is over the same range of angles.

3. The method of claim 1, wherein the first and the one or more additional time periods overlap.

4. The method of claim 1, wherein the first and the one or more additional time periods are consecutive.

5. The method of claim 1, wherein the steering of the beam in an azimuth is periodic during the time period including the first and the one or more additional time periods.

6. The method of claim 2, wherein the steering over the first range of angles is in the forward direction.

7. The method of claim 2, wherein the SAR beam is steered electronically over the first range of angles.

8. The method of claim 7, wherein the electronic steering is performed using a phased array antenna.

9. The method of claim 1, further comprising steering the SAR beam in elevation between successive data acquisitions.

10. The method of claim 9 wherein the SAR beam is steered electronically in elevation.

11. The method of claim 1, wherein the SAR beam is steered mechanically in the rearward direction.

12. The method of claim 11, wherein the mechanical steering is performed by changing the orientation of the SAR with respect to the platform.

13. The method of claim 11, wherein the mechanical steering is performed by changing the orientation of the platform with respect to the surface of Earth.

14. The method of claim 2, wherein the first range of angles is at least from +8 degrees from −8 degrees.

15. The method of claim 1, wherein the steering in the rearward direction is over a range of angles at least from −10 degrees to +10 degrees.

16. The method of claim 1 further comprising:
receiving requests for images of multiple areas on Earth,
identifying a subset of the multiple areas on Earth that are sufficiently close for image data relating to those multiple areas on Earth to be acquired during a prolonged dwell over a larger area on Earth including the multiple areas on Earth, and
determining a sequence of steering operations to be performed by a satellite to enable image data relating to the subset of the multiple areas to be acquired during the prolonged dwell,
communicating the determined sequence of steering operations to SAR control equipment on the satellite.

17. A non-transitory computer readable medium comprising computer processor executable instructions which when executed by a computer processor in a computing system cause the computing system to operate a synthetic aperture radar (SAR) carried on a platform travelling with respect to the surface of Earth and having a SAR beam directed toward the surface of Earth to effect the method of:
steering the SAR beam in azimuth with respect to the direction of travel during a first time period to acquire image data for a first area on Earth to be imaged;
steering the SAR beam in azimuth during one or more additional time periods to acquire image data for one or more additional areas on Earth to be imaged; and
steering the SAR beam in azimuth in a rearward direction with respect to the direction of travel, during a time period including the first and the one or more additional time periods, to reduce the speed of travel of the beam with respect to Earth.

18. A multi-spot imaging system comprising a satellite for operation in orbit around Earth, the satellite comprising:
a propulsion system
an attitude determination and control system (ADCS) configured for steering the SAR beam in a rearward direction
one or more radar antennas or antenna arrays configured for steering the SAR beam in azimuth over the first range of angles
synthetic aperture radar (SAR) image data acquisition apparatus
a communication system configured to send and receive signals to and from one or more ground stations on Earth; and
a non-transitory computer readable medium comprising computer processor executable instructions which when executed by a computer processor in a computing system cause the computing system to operate the satellite to (a) steer the SAR beam in azimuth with respect to the direction of travel during a first time period to acquire image data for a first area on Earth to be imaged, (b) steer the SAR beam in azimuth during one or more additional time periods to acquire image data for one or more additional areas on Earth to be imaged, and (c) steer the SAR beam in azimuth in a rearward direction with respect to the direction of travel, during a time period including the first and the one or more additional time periods, to reduce the speed of travel of the beam with respect to Earth.

19. The multi-spot imaging system of claim 18 further comprising a ground station, wherein the ground station is configured for implementing one or more of the following operations:
receiving requests for images of multiple areas on Earth,
identifying a subset of the multiple areas on Earth that are sufficiently close for image data relating to those multiple areas on Earth to be acquired during a prolonged dwell over a larger area on Earth including the multiple areas on Earth,
determining a sequence of steering operations to be performed by a satellite to enable image data relating to the subset of the multiple areas to be acquired during the prolonged dwell, and
communicating the determined sequence of steering operations to SAR control equipment on the satellite.
